(19) United States
(12) Patent Application Publication
(10) Pub. No.: US 2010/0274925 A1
(43) Pub. Date: Oct. 28, 2010

(54) DEVICE AND METHOD FOR THE AUTOMATIC INSERTION, IN DATA, OF AN ITEM OF CONCEALED INFORMATION, AND A MECHANISM FOR BROADCASTING SAME

(75) Inventor: Jean-Francois Rubon, Gemenos (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/808,850

(22) PCT Filed: Dec. 17, 2008
(86) PCT No.: PCT/EP08/67804

§ 371 Date: Jul. 13, 2010

(30) Foreign Application Priority Data
Dec. 21, 2007 (EP) 07301732.9

(51) Int. Cl. G06F 15/16

(52) U.S. Cl. 709/246

(57) ABSTRACT

The invention relates to a method for inserting, into a data stream, at least one piece of concealed information as well as at least one mechanism for broadcasting the information, wherein the mechanism is revealed. According to the invention, these additions are made without altering the original data, i.e. neither their intrinsic content nor their integrity. The invention also relates to a device for implementing the method.

The invention concerns a device and method for the automatic insertion of an item of concealed information in data, and a mechanism for broadcasting same.

The invention relates in particular to a method making it possible, in a data stream, to insert at least one item of concealed information, as well as a mechanism for broadcasting this information.

In the present document, the term “data” will designate a set of contents requested and expected by the user. In a related manner, the term “information” will be used to designate one or more items of information added, according to the invention, to data. “Concealed” information will designate information that is available only at the request of the user, following an intentional action on his part. The information will be broadcast in addition to the data requested by the user.

The expression “without altering” means that the data to which the expression implies are not modified, neither in their intrinsic content nor in their integrity.

In the same way, a strong distinction will be made between:
A “revealing”, which will designate use of a set of means for informing the user for whom a set of data is intended that the concealed information is available, and which is the operating method for accessing same.
The action of “broadcasting”, which consists of ensuring that the information or the data to be broadcast and the user are directly connected. For example, the display of an automatic window (pop-up), in the foreground of the screen, is a broadcasting of the content of the said window.

The present invention applies in particular in the following situation:
a user requests access to data,
a third party wishes to supply additional information to him.

In the majority of cases, this additional information is linked, closely or at a distance, with advertising content.

At the present time, there exist mainly two solutions that enable a third party to make such an addition of information.

A first solution consists of modifying the content of a set of data by adding information. This is for example a method that is normally used in relation to HTML (HyperText Markup Language) pages that can be consulted via the internet. In this case, advertising banners are added directly on the site hosting the said pages.

This solution has major drawbacks. A first one lies in the fact that the data requested by the user are altered. In addition, the information added must be known to the server containing the expected data.

Another solution consists of modifying a set of data at the moment of display thereof. Some internet browsers (referred to as web browsers) can add information to an HTML page, at the time of display.

In this solution, as in the previous one, the data expected by the user are altered. In addition, this solution relies on a software system responsible for the display, generally controlled by the user. This does not guarantee control of this step to a third party.

The present invention proposes to remedy these drawbacks. A method and process are provided enabling a third party to have all or part of the control of the information addition mechanism without altering the data expected by the user. The invention promotes a wide choice of different information that can be added.

More precisely, the invention is a data enhancement method used in a first communicating electronic device, this first device supplying data to a second communicating electronic device, this method comprising:
an addition step consisting of the insertion, among these data, without altering them, at least one item of concealed information.
a mechanisation step consisting of the insertion, among these data, without altering them, of at least one mechanism for accessing the concealed information,
a revealing step consisting of revealing at least one mechanism for accessing the concealed information.

In an embodiment of the invention, the method can also comprise a broadcasting step by means of which software means embedded in the second communicating electronic device broadcast the data to a user of this second device.

In particular embodiments, the information may be advertising content, a link to a content local to the first communicating electronic device, or a link to a content external to the first communicating electronic device.

In one embodiment of the invention, the mechanism uses a functionality provided by the second communicating electronic device. This functionality may for example be an opening of a display zone containing the information, or the audible sending of the information.

In one embodiment of the invention, the revealing may be done by modifying display properties of all or some of the data.

According to one embodiment of the invention, in a preliminary step, the software means for receiving data by the second communicating electronic device are configured in order to receive data only from the second communicating electronic device.

The invention is also a first communicating electronic device connected to a second communicating electronic device, the first electronic device having means for:
receiving requests for data issuing from the second communicating device;
obtaining these data;
inserting, among these data, without altering them, at least one item of concealed information;
inserting, among these data, without altering them, at least one mechanism for accessing the said concealed information;
revealing at least one mechanism for accessing the concealed information;
transmitting the data, thus enhanced, to the second device.

In distinct embodiments, the electronic device may for example be included in the said second electronic device, or it may be connected physically to the second electronic device. In another embodiment the electronic device may communicate with the second electronic device, for example through a radio-frequency link.

In distinct embodiments, the information may for example be stored in a memory of the said electronic device, or in a distant memory.

In one embodiment, the said second device according to the invention comprises means for downloading the information.

In one embodiment, the said first electronic device is a chip card.

The invention advantageously makes it possible for the device responsible for adding the information to the data to be in the direct vicinity of the user. This enables this device, in a particular embodiment, to collect information relating to the user and to the data that he is requesting. This device can then very finely adapt the information to be inserted to the user and/or to the data.

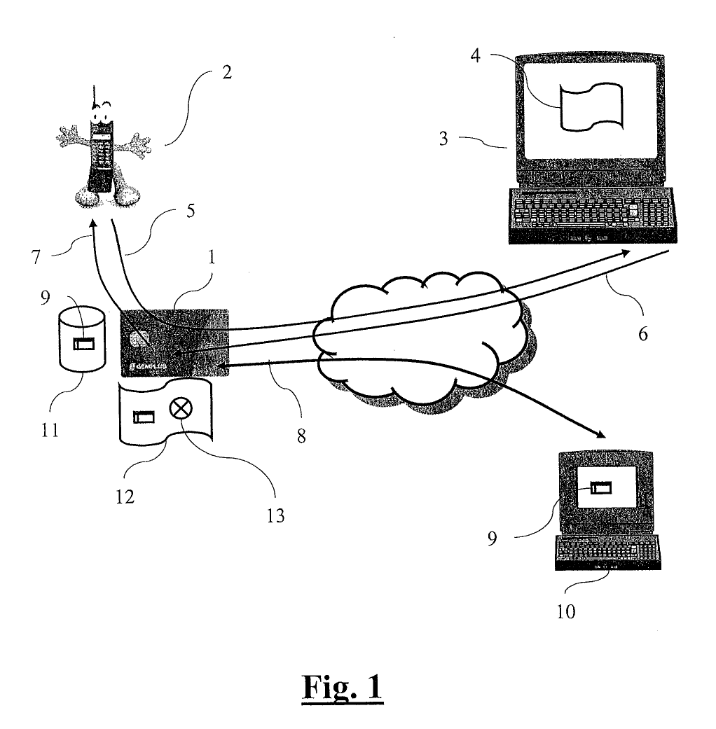

Other features and advantages of the invention will emerge clearly from the description that is given thereof below, by way of indication and in no way limitatively, with reference to the accompanying FIG. 1:

FIG. 1 describes a system for enhancing data according to the invention.

In FIG. 1, the first electronic device is a chip card 1, and the second communicating electronic device is a portable telephone 2.

The card 1 is an element functionally independent of the telephone 2. This enables this element to belong to a third party. Generally, in the majority of uses of mobile telephones the SIM (Subscriber Identity Module) card is the property of the telephone operator. The telephone belongs to the user. Thus the invention enables the operator to control the insertion of concealed information, although he does not control the telephone.

The user, through software means embedded in the portable telephone 2, requests to have access to data 4 contained in a distant computer 3. This is for example the case where the software means are a “web browser”, and the user requests to consult an HTML page identified.

The demand by the user is represented in the form of a request 5, transmitted to the card 1.

The fact that this request is directed to the card can come from the system per se, be a choice of the user, or be related to a particular configuration of the telephone.

In relation to FIG. 1, the card 1 receives 6 the data 4 from the distant computer 3. However, as described previously, the card 1 can obtain these data 4 from any source, or in a particularly advantageous case have them available in a local memory 11.

Through implementation of the method according to the invention, the card 1 can enhance the data 4 with concealed information 9. This information 9 may be present in a memory 11, internal to the card, or distant within a distant computer 10. These cases are emblematic of the situations where the advertising content to be inserted in the data is stored in the card, or the said content is downloaded 8 from a dedicated server.

An intermediate situation may arise in the case where the information 9 is a reference to a distant content. In the internet world this reference is an internet address, more generally referred to as the URL (Uniform Resource Locator). A distant content is not repatriated, but only indexed.

Once the card has concealed the information 9 in the data 3, without altering it, it must now add thereto at least one mechanism 13, and reveal this, still without altering the data.

In our example in relation to the internet, the mechanism for accessing the concealed information 13 may for example be a window containing the information. This window appears if the user “clicks” on a particular word on the HTML page 4. The revealing may be done by highlighting the word in question in order to indicate to the user that information is accessible through this particular word.

The data thus enhanced 12 are transmitted 7 to the telephone 2 in which the software means broadcast them to the user.

1-18. (canceled)

19. A data enhancement method used in a first communicating electronic device, said first device supplying data to a second communicating electronic device, wherein said first device is included in said second device and said method comprises:
an addition step including the insertion, among said data, without altering them, at least one item of concealed information;
a mechanisation step including of the insertion, among said data, without altering them, of at least one mechanism for accessing said concealed information; and
a revealing step including revealing at least one mechanism for accessing said concealed information, said addition and mechanisation steps being implemented in said first device.

20. A method according to claim 19, further comprising a broadcasting step in which software embedded in said second device broadcasts the data to a user of said second device.

21. A method according to claim 19, wherein the information is an advertising content.

22. A method according to claim 19, wherein the information is a link to a content local to said first device.

23. A method according to claim 19, wherein the information is a link to a content external to said first device.

24. A method according to claim 19, wherein the mechanism uses a functionality provided by said second device.

25. A method according to claim 24, wherein the mechanism is an opening of a display zone containing said information.

26. A method according to claim 24, wherein the mechanism is an audible sending of said information.

27. A method according to claim 19, wherein the revealing is done by modifying the display properties of all or some of said data.

28. A method according to claim 20, wherein, in a preliminary step, software enabling the data to be received by the second device is configured to receive data only from the first device.

29. A communicating electronic device, referred to as the first device, included in a second communicating electronic device, wherein the first electronic device is configured to:
receive requests for data issuing from the second device;
obtain said data;
insert, among said data, without altering them, at least one item of concealed information;
insert, among said data, without altering them, at least one mechanism for accessing said concealed information;
reveal at least one mechanism for accessing the concealed information; and
transmit the data, with the inserted information and mechanism, to the second device.

30. An electronic device according to claim 29, wherein said information is stored in a memory of said first device.

31. An electronic device according to claim 29, further comprising means for downloading said information.

32. An electronic device according to claim 29, wherein said first device is a chip card.
